(19) United States
(12) Patent Application Publication
(10) Pub. No.: US 2026/0147771 A1
(43) Pub. Date: May 28, 2026

(54) TECHNIQUES TO DYNAMICALLY RETRIEVE DOCUMENTS USING SEMANTIC AND TEMPORAL CUES

(71) Applicant: Oracle International Corporation, Redwood Shores, CA (US)

(72) Inventors: Srijon Sarkar, Bangalore (IN); Pritam Kumar Nath, Kolkata (IN); Suman Roy, Bangalore (IN)

(73) Assignee: Oracle International Corporation, Redwood Shores, CA (US)

(21) Appl. No.: 19/199,179

(22) Filed: May 5, 2025

(30) Foreign Application Priority Data
Nov. 28, 2024 (IN) 202441093076

(51) Int. Cl. G06F 16/2457; G06F 16/93

(52) U.S. Cl. CPC G06F 16/24578; G06F 16/93

(57) ABSTRACT

Techniques include accessing a set of documents; generating a final unified representation for each document of the set of documents, wherein generating the final unified representation comprises performing an iterative process for each document, and wherein the iterative process comprises: encoding, using a semantic embedding vector, a document's core semantic features in a semantic encoding, mapping a time domain for at least the document into a dimensional vector space to encode temporal information into a temporal encoding, and aggregating the semantic encoding and temporal encoding to generate the final unified representation; generating a query embedding, where the query embedding comprises a time-aware embedding for a query; comparing the query embedding to the final unified representation for each document of the set of documents; identifying one or more documents of the set of documents based on the comparing; and providing the one or more identified documents for downstream use.

### CROSS-REFERENCE TO RELATED APPLICATION

The present application is a non-provisional application of and claims the benefit and priority under 35 U.S.C. 119 (e) of Indian Provisional Application No. 202441093076, filed Nov. 28, 2024, the entire contents of which is incorporated herein by reference for all purposes.

### FIELD

The present disclosure relates generally to large language model adaptation, and more particularly, to systems and methods to dynamically retrieve documents using semantic and temporal cues.

### BACKGROUND

Large Language Models (LLMs), such as those based on transformer architectures, have demonstrated significant advancements in natural language processing and understanding. These models are trained on vast corpora of text data, enabling them to perform a wide range of tasks including text generation, translation, summarization, and question answering with high proficiency. Their ability to learn from large datasets allows them to capture nuanced language patterns and contextual meanings, making them versatile tools in various applications ranging from customer service to legal research.

Despite their impressive capabilities, LLMs operate on a static knowledge base that is only as current as the data they were trained on. This inherent limitation becomes particularly pronounced when dealing with time-sensitive queries that require up-to-date information. For example, LLMs may struggle to accurately respond to questions about recent events, newly enacted laws, or emerging technological developments. This discrepancy between their extensive training data and the need for real-time information significantly hampers their utility in scenarios where current knowledge is paramount.

The static nature of LLMs' knowledge base stems from the fact that they do not have real-time access to new data post-training. The process of updating an LLM involves retraining or fine-tuning the model with new datasets, which can be computationally expensive and time-consuming. Consequently, the lag between the availability of new information and its incorporation into the model's knowledge base can render the LLM less effective for applications that require immediate, up-to-date responses.

To address these challenges, innovative approaches are being explored to enhance the temporal relevance of LLMs. One such approach involves integrating LLMs with external data sources that provide real-time information, thereby allowing the model to access and incorporate the latest data dynamically. Another strategy includes the development of hybrid models that combine the strengths of LLMs with other technologies capable of real-time data processing. By bridging the gap between static training data and real-time information needs, these advancements aim to significantly improve the efficacy of LLMs in addressing time-sensitive queries, ultimately expanding their applicability and utility in a rapidly evolving information landscape.

### Summary

Described herein are embodiments (e.g., a method, a system, non-transitory computer-readable medium storing code or instructions executable by one or more processors) pertaining to dynamic retrieval of documents using semantic and temporal cues.

In various embodiments, a computer-implemented method is provided for that comprises: accessing a set of documents; generating a final unified representation for each document of the set of documents, wherein generating the final unified representation comprises performing an iterative process for each document, and wherein the iterative process comprises: encoding, using a semantic embedding vector, a document's core semantic features in a semantic encoding, mapping a time domain for at least the document into a dimensional vector space to encode temporal information into a temporal encoding, and aggregating the semantic encoding and temporal encoding to generate the final unified representation; generating a query embedding, where the query embedding comprises a time-aware embedding for a query; comparing the query embedding to the final unified representation for each document of the set of documents; identifying one or more documents of the set of documents based on the comparing; and providing the one or more identified documents for downstream use.

In some aspects, the method further includes ranking the one or more documents based on temporal relevance, wherein the documents are provided based on the ranking. In some aspects, ranking the one or more documents based on temporal relevance comprises applying a Gaussian scoring method to enhance document prioritization based on temporal proximity.

In some aspects, mapping the time domain into the dimensional vector space to encode the temporal information into the temporal encoding comprises applying Bochner's theorem to parameterize the temporal information. In some aspects, encoding the document's core semantic features in a semantic encoding comprises providing the document to encoder component of a transformer-based network that generates the semantic embedding vector.

In some aspects, aggregating the semantic encoding and the temporal encoding comprises providing the semantic encoding and the temporal encoding to a neural network that aggregates the semantic encoding using weights for the semantic encoding and the temporal encoding.

In some aspects, comparing the query embedding to the final unified representation comprises applying cosine similarity to the query embedding and the final unified representation to generate a score for the document.

In some aspects, providing the one or more identified documents for downstream use comprises providing the one or more identified documents to a remote computing device for display. In some aspects, providing the one or more identified documents for downstream use comprises providing the one or more identified documents as input to a large language model (LLM) with the query; receiving a natural language output from the LLM; and providing the natural language output to a remote computing device for display.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 illustrates an overview of techniques for dynamically retrieving documents using semantic and temporal cues in accordance with various embodiments.

FIG. 2 shows a block diagram illustrating the T-Ret architecture in accordance with various embodiments.

FIG. 3 show a block diagram illustrating an AI platform for training and deploying models in accordance with various embodiments.

FIG. 4 depicts a flowchart illustrating a document retrieval process in accordance with various embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

### Summary

Social media, research publications, and global news produce large repositories of data, which is dynamic in nature. This can pose a challenge for the task of information retrieval. Large Language Models (LLMs) have shown remarkable capability across diverse tasks, yet their static knowledge base restricts their effectiveness in addressing time-sensitive queries. While Retrieval-Augmented Language Model (RALM) models can incorporate new data, they often overlook the importance of temporal factors in determining relevance. To address these limitations, a model has been developed that combines recency and semantic relevance dynamically within a unified embedding space. This model, referred to as T-Ret, learns to adaptively balance these factors based on the query's context.

### Challenges Solved

With the rapid acceleration of data generation from diverse sources like social media, research publications, and global news, the volume of information grows exponentially. This surge in data makes knowledge increasingly dynamic. Information retrieval systems, therefore, must continuously adapt to ensure that users receive the most relevant and current knowledge whenever needed. Despite the prowess of LLMs, they are limited in handling time-sensitive information and adapting to new knowledge, as they cannot update their knowledge base post-training.

Lately, RALMs have emerged as a promising solution to this challenge. Unlike traditional LLMs, which rely exclusively on a static parametric memory set at training time, RALMs leverage an external, indexed knowledge base that can be updated independently. By accessing a dynamic document corpus, RALMs can seamlessly integrate recent information from reliable sources, such as Wikipedia and verified web pages, ensuring that model outputs remain aligned with current knowledge. Retrieval systems in RALMs can search databases for semantically relevant information, yet they frequently overlook the importance of temporal relevance, missing out on suitably answering temporal queries.

### Overview of Embodiments and Solution for Challenges

Embodiments described herein for a T-Ret retrieval system address the aforementioned challenges and others by enhancing information retrieval by integrating temporal and semantic relevance within a unified embedding space. More specifically, T-Ret addresses the aforementioned challenges and others by dynamically balancing recency and semantic relevance, ensuring that retrieved documents are both timely and contextually relevant.

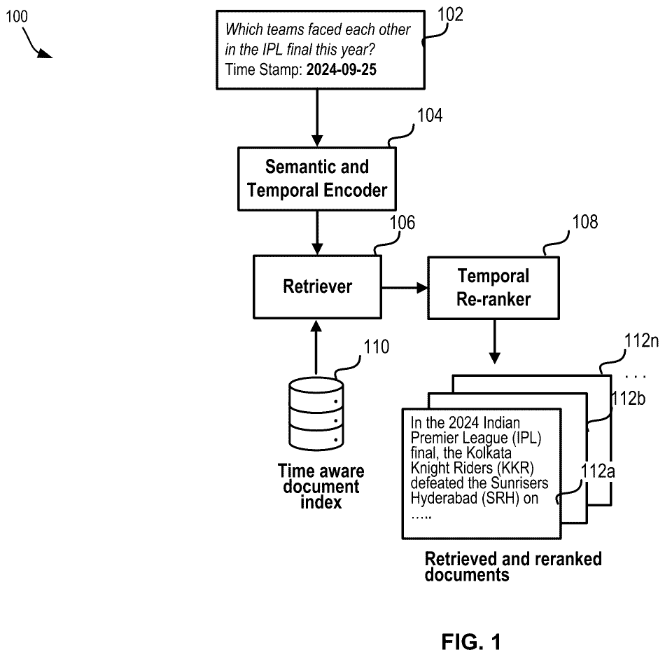

FIG. 1 illustrates an example overview of the T-Ret architecture 100, according to various embodiments. For a time-sensitive query 102, T-Ret encodes the query using its temporal-semantic encoder 104 and retrieves relevant documents 112a, 112b, . . . 112n from a time-aware index 110 using the retriever 106, followed by re-ranking with a re-temporal re-ranker 108.

Consider the following query 102 shown in FIG. 1: “Which teams faced each other in the IPL final this year?” The answer to this query is time dependent. Depending on the year a source document was generated, it may or not be relevant to the query 102. The techniques described herein leverage semantic and temporal information to ensure that results are relevant with respect to time as well as content.

### Overview of T-RET

The T-Ret model is a retrieval system that enhances temporal retrieval by unifying temporal and semantic contexts within an optimized embedding space. In some embodiments, T-Ret uses a time embedding to encode temporal information and a temporal re-ranker for further refinement based on temporal relevance.

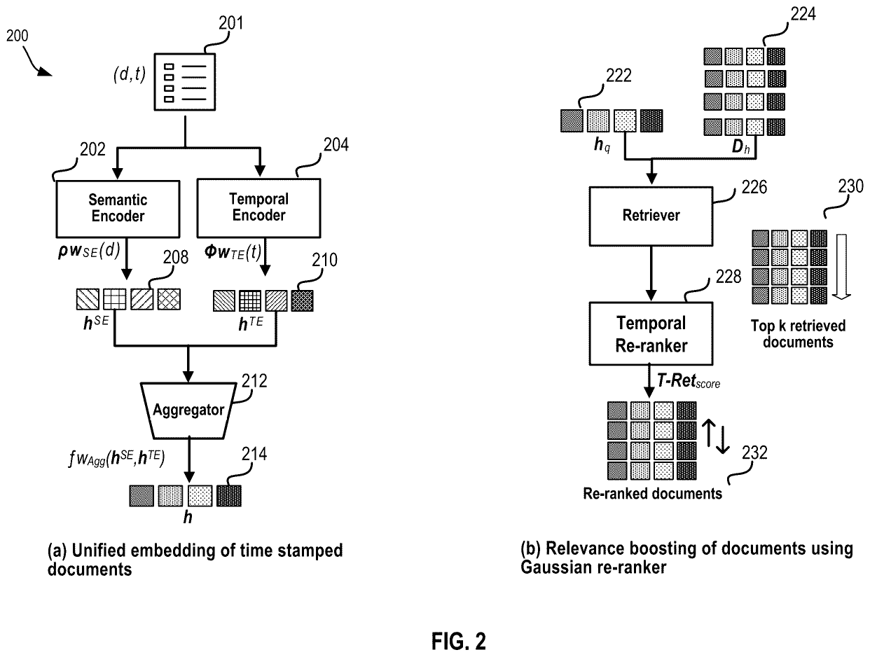

FIG. 2 illustrates an example of the T-Ret framework 200, according to various embodiments. T-Ret's architecture is comprised of four main components: a semantic encoder 202, temporal encoder 204, retriever 226, and temporal re-ranker 228. It should be appreciated that, in some other examples, the T-Ret framework 200 may have more or fewer components than those depicted in FIG. 2, may combine two or more components, or may have a different configuration or arrangement of components.

In some embodiments, the T-Ret model consumes a set of documents 201. Each document d may be stored in association with temporal information such as a timestamp t: (d,t). For example, D={dᵢ} is a collection of n timestamped documents, where dᵢ=(dᵢ, tᵢ) and dᵢ denotes the text of the i-th document, and tᵢ>0 represents its associated timestamp.

### Semantic Encoder

The semantic encoder 202 is a machine-learning model such as a neural network configured to transform text into dense semantic vectors. The semantic encoder 202 takes as input the documents 201 and generates feature embeddings. The feature embeddings can be dense vector representations of tokens (e.g., sub-words, words, etc.) in lower dimensional space. The semantic embedding vector encodes the input document's core semantic features in a dense representation, calculated using a pre-trained encoder.

In some instances, the semantic encoder 202 is a part of a pre-trained model such as Bidirectional Encoder Representations from Transformers (BERT), Sentence-BERT, or another suitable encoder. BERT is a transformer-based network that includes an encoder component and a decoder component. (See Devlin et al., “BERT: Pre-training of Deep Bidirectional Transformers for Language Understanding,” arXiv: 1810.04805 (2018)). BERT can be used for contextual embeddings. Alternatively, or additionally, any suitable encoder can be applied, such as Sentence-BERT for sentence-level tasks, Universal Sentence Encoder for broad applicability, and Sentence-T5 for scalable embeddings. T-Ret's modular framework can integrate these or other encoders, ensuring adaptability to improve temporal retrieval. In some examples the semantic encoder 202 is a subset of the layers of BERT.

In some instances, the semantic encoder 202 generates a semantic embedding vector h^{SE} 208. The semantic embedding vector h^{SE} 208 encodes the document's core semantic features in a dense representation, calculated using a pre-trained encoder as follows: h^{SE}=ρw_{SE} (d). Here, W_{SE} represents the pre-trained weights of the semantic encoder captured using a non-linear function ‘ρ’. In some instances, these parameters remain frozen.

### Temporal Encoder

The temporal encoder 204 is a machine-learning model such as a neural network configured to map time into a continuous vector space, effectively encoding temporal information. In some instances, a continuous function is defined as

$$Φ : T \to {ℝ}^{{dim}_{TE}}$$

This function maps the time domain T into a dim_{TE} dimensional vector space to encode temporal information. For simplicity, it can be assumed that the time domain can be represented as an interval T=[0, tₘₐₓ], where tₘₐₓ is based on the data's observed maximum time value, as the original dense time T can be mapped (one-to-one) to the interval [0, tₘₐₓ].

In some instances, the temporal encoder 204 is implemented using Bochner's time embedding. In such implementations, Bochner's theorem is leveraged, which enables the parameterization of positive semi-definite (PSD) and continuous kernels. This produces the time embedding h^{TE} 210, where:

$${h}^{TE} = {Φ}_{{W}_{TE}} = \frac{1}{\sqrt{d}} ( cos ( {ω}_{1} t ) , sin ( {ω}_{1} t ) , … , cos ( {ω}_{d} t ) , sin ( {ω}_{d} t ) ) .$$

Alternatively, or additionally, one can identify candidate functional forms of this function by using principles of classic functional analysis. In some instances, the temporal encoder 204 can include a Temporal Retriever Augmented Language Model (TRALM) as described in Gade et al., It's about time: Incorporating temporality in retrieval augmented language models (2024), https://arxiv.org/abs/2401.13222).

### Aggregator

The aggregator 212 is configured to aggregate the semantic encoding h^{SE} 208 and the temporal encoding h^{TE} 210. The aggregator 212 may, for example, be a fully connected neural network that applies the aggregation function ƒ. As a specific example, the aggregator 212 can be implemented as a two-layer neural network configured to aggregate the input encodings.

In some instances, the semantic encoding h^{SE} 208 and the temporal encoding h^{TE} 210 are passed to the aggregator 212, which produces a final unified representation h 214 that aggregates both the semantic and temporal embeddings:

$$h = {fw}_{Agg} ( {h}^{SE} , {h}^{TE} ) .$$

The encoded embeddings are represented as hᵢ for the i^{th} document dᵢ. In some implementations, the documents are organized within a temporally indexed vector database, denoted as Dh 224.

### Retriever

The retriever 226 matches incoming queries with relevant documents. In some examples, the retriever performs the matching using time-aware embeddings. An annotated query is a pair, \tilde{q}=(q, d*), where q=(d_{q}, t_{q}) consists of a query text d_{q} and an associated query timestamp t_{q}. When a query (d_{q}, t_{q}) arrives at runtime, its corresponding time-aware embedding h_{q} 222 is generated.

The query embedding h_{q} 222 is then compared against the indexed document embeddings hᵢ. The comparison can be performed using cosine similarity or another suitable technique. Using cosine similarity for the comparison has been found to allow for fast retrieval based on both content and temporal proximity. For example, cosine similarity can be used to generate a similarity score s, given by:

$$s ( q , d ) = \frac{{h}_{q} , {h}_{d}}{‖ {h}_{q} ‖ ‖ {h}_{d} ‖}$$

Based on the score s, the retriever 226 retrieves a subset of the documents. In some instances, a configurable number k of documents is retrieved. For example, k can be a hyperparameter of the model, which can be set to 100 or any other suitable value. As shown in FIG. 2, the top k documents 230 are retrieved.

### Temporal Re-Ranker

The temporal re-ranker 228 reorders the retrieved documents based on temporal relevance, generating re-ranked documents 232. In some implementations, the re-ranking is performed through a Gaussian scoring method. This combined approach ensures that T-Ret can prioritize documents that are both semantically and temporally relevant to the query.

In some instances, the temporal re-ranker is implemented using a Gaussian scorer. The Gaussian-scorer method applies a Gaussian function to score documents by their proximity to the query time. For a query time t_{q} and document time t, the temporal score τ(t_{q}, t) is given as:

$$τ ( {t}_{q} , t ) = {e}^{- 0.5 \times {( \frac{( {t}_{q} - t ) - μ}{σ} )}^{2}}$$

The parameters σ and μ are computed from the document set D. The kernel t is designed to operate on the time difference between the query and the documents, ensuring temporal relevance. A key property of t is its validity as a kernel, which implies the existence of an inner product space H and a mapping ψ: R→H such that

$$τ ( {t}_{1} , {t}_{2} ) = ψ ( {t}_{1} ) , ψ ( {t}_{2} ) H ,$$

as established by Mercer's theorem (see Mercer, “Functions of positive and negative type, and their connection with the theory of integral equations,” Philosophical Transactions of the Royal Society, London 209, 415-446 (1909)). This formulation highlights that the re-ranker effectively transforms the timestamps into the space H, enabling the model to capture and learn temporal similarities through kernel representation.

The overall similarity score for each document d·=(d, t) with respect to a query q·=(d_{q}, t_{q}) is computed by combining the semantic relevance score s (q, d) and the normalized temporal relevance score τ(t_{q}, t). The similarity score between a query and document by this model is called T-Ret_{score}.

$$T - {Ret}_{score} ( q , d ) = ( 1 - λ ) \cdot s ( q , d ) + λ \cdot τ ( {t}_{q} , t ) , 0 \leq λ \leq 1$$

λ is a weight parameter that balances the importance of semantic and temporal relevance. Finally, the most relevant document can then be selected by finding the maximum of the T-Ret scores. For example, the T-Ret scores are maximized on the document set D to find a document d* in D such that

$$d * \cdot = arg max T - {Ret}_{score} ( q , d )$$

$$D ∈ D$$

In some aspects, the training of the unified embedding involves minimizing a margin-based ranking loss to ensure that the distance between the query embedding and the positive document embedding is smaller than the distance to a negative document embedding by a margin m. The training process involves minimizing a margin-based ranking loss to distinguish between positive and negative document pairs. In some examples, the following loss function is minimized:

$$ℒ ( \overline{q} , {d}_{neg} ) = max ( 0 , m + {‖ {h}_{q} - {h}_{d} ‖}^{2} - {‖ {h}_{q} - {h}_{{d}_{neg}} ‖}^{2} )$$

where q̅=(q, d) represents a pair of query q and a positive document d, while d_{neg} ∈ D\ {d} denotes a negative document sampled from the document set D excluding d. The objective is to enforce a separation margin m between positive and negative pairs, facilitating better discrimination in the embedding space.

### AI Platform

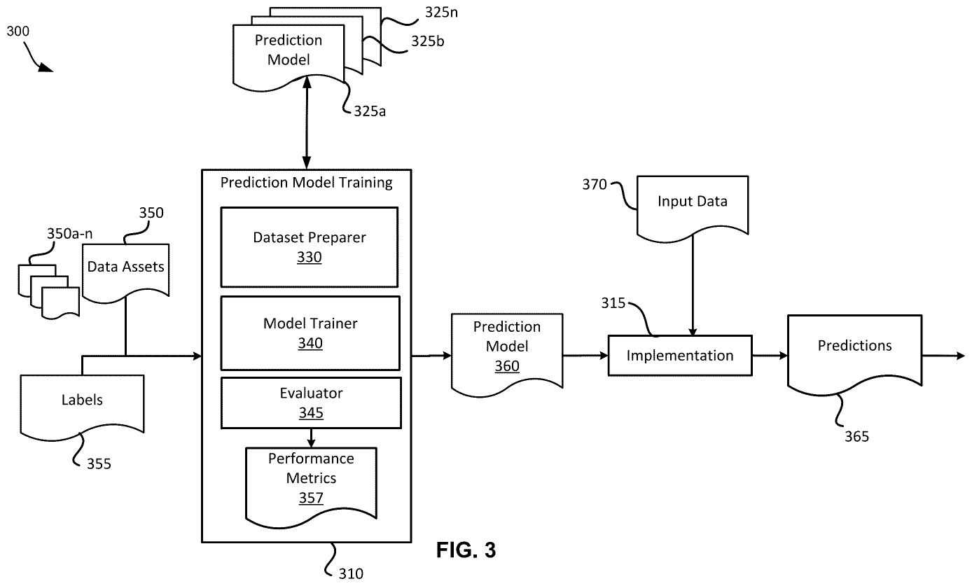

FIG. 3 is a block diagram illustrating a AI platform 300 in accordance with various embodiments. The AI platform 300 can be used in cooperation with the components described above with respect to FIGS. 1 and 2 for training and deployment of the models. The AI platform 300 in this example includes various stages: a training stage 310 to build and train models and an implementation stage 315 for implementing one or more models. The training stage 310 builds and trains one or more machine learning models 325a-325n (‘n’ represents any natural number) to be used by the other stages (which may be referred to herein individually as a prediction model 325 or collectively as the prediction models 325). For example, the prediction models 325 can include a model for predicting the sentiment of a participant. Still other types of prediction models may be implemented in other examples according to this disclosure such as generalized text-based sentiment analysis, aspect-based sentiment analysis, fine-grained sentiment analysis, sentiment classifier, and the like.

A prediction model 325 can be a machine-learning model, as described herein with respect to model T-Ret. To train the various prediction models 325, the training stage 310 is comprised of three main subsystems or services: dataset preparer 330, model trainer 340, and evaluator 345. The dataset preparer 330 performs the processes of loading data assets 350 (e.g., query and document samples (or embeddings thereof) labeled), splitting the data assets 350 into training and validation sets 350 a-n so that the system can train and test the prediction models 325, and preprocessing of training and validation sets 350 a-n. The splitting may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting. The training and validation sets 350 includes at least one dataset of text samples and/or pre-trained embeddings like Word2Vec, GloVe, or contextual embeddings like BERT, which capture semantic meaning. The preprocessing of training and validation sets 350 may include one or more of the following steps. Clean the text data by removing noise such as punctuation, special characters, and stop words. Tokenize the text into words or subwords. Convert the text data into numerical representations that can be fed into a deep learning model (e.g., using Bag-of-Words, Term Frequency-Inverse Document Frequency (TF-IDF), or Word Embeddings).

The model trainer 340 performs the processes of determining hyperparameters for the model 325 and performing iterative operations of inputting examples from the training data 345a into the model 325 to find a set of model parameters (e.g., weights and/or biases) that minimizes a cost function(s) such as loss or error function for the model 325. The hyperparameters are settings that can be tuned or optimized to control the behavior of the model 325. Most models explicitly define hyperparameters that control different features of the models such as memory or cost of execution. However, additional hyperparameters may be defined to adapt the model 325 to a specific scenario. For example, learning rate, number of iterations, regularization weight or strength, and the like. The cost function can be constructed to measure the difference between the outputs inferred using the model 325 and the ground truth annotated to the samples using the labels. For example, for a supervised learning-based model, the goal of the training is to learn a function “h ( )” (also sometimes referred to as the hypothesis function) that maps the training input space X to the target value space Y, h: X→Y, such that h (x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

Once the set of model parameters are identified, the model 325 has been trained and the evaluator 345 performs the additional processes of testing or validation using the subset of testing data 350b (testing or validation data set). The testing or validation processes includes iterative operations of inputting utterances from the subset of testing data 350b into the model 325 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set from the subset of test data 350a may be input into the model 325 to obtain output (in this example context, retrieval of documents and/or ranking of retrieved documents), and the output is evaluated versus ground truth entities using correlation techniques such as Bland-Altman method and the Spearman's rank correlation coefficients. Further, performance metrics 357 may be calculated in evaluation stage 315 such as the error, accuracy, precision, recall, receiver operating characteristic curve (ROC), etc. The metrics 357 may be used in the evaluator 345 to analyze performance of the model 325 for providing recommendations on training and hyperparameter optimization.

As should be understood, other training/validation mechanisms are contemplated and may be implemented within the AI platform 300. For example, the model 325 may be trained and model parameters may be tuned on data assets from a subset of obtained or filtered datasets and the datasets from a subset of obtained or filtered datasets may only be used for testing and evaluating performance of the model 325. Moreover, although the training mechanisms described herein focus on training a new model 325, these training mechanisms can also be utilized to fine tune existing models trained from other datasets. For example, in some instances, a model 325 might have been pre-trained using data assets from one or more different modalities or tasks. In those cases, the models 325 can be used for transfer learning and retrained/validated using the training and validating data as described above.

The model training stage 310 outputs trained models including one or more trained prediction models 360. The one or more trained prediction models 360 may be deployed and used in the implementation stage 315 for providing predictions 365 to users (see, e.g., the discussion of model T-Ret with respect to FIG. 1). For example, prediction models 360 may receive input data 370 including document text and/or one or more queries and provide predictions 365 (e.g., retrieval of documents and/or ranking of retrieved documents) to a user based on features determined from the document text and/or queries.

While not explicitly shown, it will be appreciated that the model system 300 may further include a developer device associated with a developer. Communications from a developer device to components of the model system 300 may indicate what types of descriptive text and/or definitive feedback are to be used for the models, a number and type of models to be used, hyperparameters of each model, for example, learning rate and number of hidden layers, how data requests are to be formatted, which training data is to be used (e.g., and how to gain access to the training data) and which validation technique is to be used, and/or how the controller processes are to be configured.

### Techniques for Document Retrieval

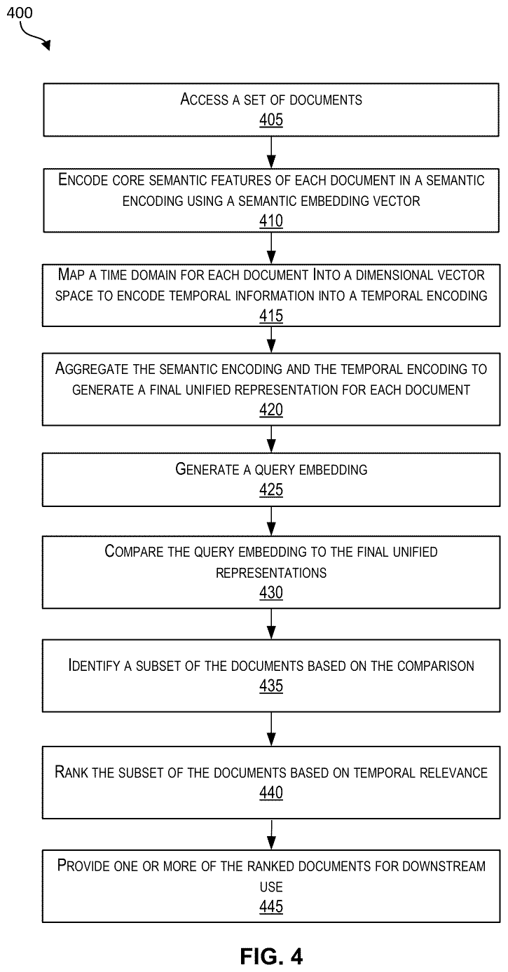

FIG. 4 depicts a simplified flowchart 400 depicting a document retrieval process, which may be implemented by the T-Ret architecture of FIG. 2 according to certain embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order or some steps may also be performed in parallel.

The process commences in step 405, in which a set of documents is accessed. The documents may be reference documents to be accessed for applications such as retrieval-augmented generation (RAG) or other retrieval tasks. The documents may include text data and temporal data such as a timestamp. In some instances, a timestamp may be stored as metadata associated with each document.

At steps 410-420, a final unified representation is generated for each document of the set of documents. The generating the final unified representation comprises performing an iterative process for each document. The iterative process includes steps 410-420, which may be repeated for each document.

At step 410, a document's core semantic features are encoded in a semantic encoding. In various implementations, the encoding is executed using a semantic embedding vector. As described above with respect to FIG. 2, the semantic encoder 202 transforms text of the input documents into dense semantic vectors. The semantic encoder 202 takes as input the documents 201 and generates feature embeddings (e.g., h^{SE} 208 shown in FIG. 2). The feature embeddings can be dense vector representations of tokens (e.g., sub-words, words, etc.) in lower dimensional space. The semantic embedding vector encodes the input document's core semantic features in a dense representation.

At step 415, a time domain for at least the document is mapped into a dimensional vector space to encode temporal information into a temporal encoding. As described above with respect to FIG. 2, in various implementations, the temporal encoder 204 is a maps time into a continuous vector space, effectively encoding temporal information to produce a temporal encoding (e.g., h^{TE} 210 shown in FIG. 2). A function such as Bocher's maps the time domain T into a dim_{TE} dimensional vector space to encode temporal information. This time domain may represent the documents in the input dataset.

At step 420 the semantic encoding and temporal encoding are aggregated to generate a final unified representation. This is iterated for each document to generate a final unified representation for each document. In some examples, the aggregation is performed using an aggregator 212 as shown in FIG. 2, which is a machine learning model such as a fully connected neural network. The aggregator 212 aggregates the semantic encoding and the temporal encoding (e.g., h^{SE} 208 and h^{TE} 210 shown in FIG. 2). In some aspects, the aggregation includes weights for the semantic encoding and/or the temporal encoding.

Subsequently, a query is received. For example, a user may input the query into a user device, which transmits the query to the system over a network. The query may represent information the user seeks from the documents processed at steps 405-420. For example, the user may interact with a service such as a help center to submit the query. In a specific example, a search bar is displayed, allowing users to retrieve documentation for different services or features. If there are multiple pages for a service, it is preferable for the latest page to be displayed on top, to provide the most up-to-date information. Alternatively, or additionally, the user may interact with a RAG agent to provide their query and receive a natural language response based on the information in the documents. The system may identify a time t_{q} that a query d_{q} is received for retrieving temporally relevant documents. This creates a joint embedding space that integrates temporal and semantic contexts by employing Bochner's theorem for efficient Fourier-based time representation.

At step 425, a query embedding, which is a corresponding time-aware embedding for a query, is generated. For example, when a query (d_{q}, t_{q}) arrives at runtime, its corresponding time-aware embedding h_{q} 222 is generated. In some instances, generating the query embedding is performed in a similar fashion to generating the unified representation at steps 410-420.

At step 430, the query embedding is compared to the final unified representation for each document of the set of documents. As described above with respect to FIG. 2, the query embedding can be compared against the indexed document embeddings using cosine similarity or another suitable technique. In some instances, the comparison generates a score representing the similarity of each document to the query in a time-aware fashion.

At step 435, a subset of the set of documents is identified based on the comparing. Based on the score based on the comparison at step 430, a subset of the documents is identified. For example, a configurable number k of documents is identified (e.g., 100 documents). Identifying the documents may include retrieving the documents, flagging the documents, or otherwise selecting the documents.

At step 440, the one or more documents are ranked based on temporal relevance. In some aspects, the documents are re-ranked, which has been found to provide improved results. In some implementations, the re-ranking is performed through a Gaussian scoring method, as described above with respect to the temporal re-ranker 228 of FIG. 2. A temporal re-ranking method using Gaussian sampling enhances document prioritization based on temporal proximity.

At step 445, one or more of the documents is provided for downstream use. In some instances, the one or more documents are selected based on the ranking at step 440. For example, the top one, two, three, or more documents are selected based on the re-ranking at step 440. Alternatively, in other implementations, the documents may be ranked based on the scores generated at step 430 without reranking.

In some instances, providing the documents for downstream use includes providing the documents as part of a prompt to a machine learning model such as an LLM. For example, the LLM is given a query, and the documents are identified as context for the query using RAG techniques. After identifying some number of documents most relevant to the query, the prompt and the documents are provided to the LLM. The LLM can then generate and output a natural language response to the query using the context provided by the selected documents. Accordingly, in some aspects, providing the one or more identified documents for downstream use comprises: providing the one or more identified documents as input to a large language model (LLM) with the query; receiving a natural language output from the LLM; and providing the natural language output to a remote computing device for display. The natural language may be displayed on a display component of the computing device from which the query was received. Alternatively, the natural language output can be converted to speech output and output via a speaker.

Alternatively, or additionally, providing the documents for downstream use may include providing the documents as output. For example, the documents can be transmitted electronically to a user device and/or displayed on a display component of a user device. In other words, in some aspects, providing the one or more identified documents for downstream use comprises providing the one or more identified documents to a remote computing device for display.

As further detailed below, by incorporating temporal factors along with semantic ones, these techniques provide significant accuracy improvements for retrieving relevant documents. This will improve the ensuing downstream task such as providing the user with the most relevant documents and/or allowing the LLM to provide an answer informed by the correct information.

### Examples

The following examples illustrate the improved efficiency and effectiveness of the T-Ret techniques described herein. Performance was benchmarked in time-aware retrieval, analyzing the impact of various temporal encoders, reranking functions, and base semantic encoders on retrieval accuracy and temporal relevance.

Experiments conducted on datasets such as Tennis, Politics, News comments, and IPL demonstrate T-Ret's superior performance in retrieval accuracy and temporal relevance compared to other models.

### Datasets

To evaluate T-Ret's effectiveness with time-sensitive queries, time stamped datasets were used across various domains to assess the model's balance of semantic relevance and temporal proximity. The following datasets were used:
1. Tennis Dataset: Following TempRALM, a tennis dataset of grand slam match data (1928-2024) was used. This data set summarizes match details (tournament, scores, date) into timestamped documents. This dataset suits the method well, as relevance shifts with both query semantics and timing.
2. Politics: The Polusa dataset contains 900,000 U.S. news articles across 18 political-spectrum news outlets, dated for tracking policy topic evolution. This dataset helps test the efficacy of the model's retrieval of contextually relevant, time-sensitive articles.
3. News comments: The New York Times comments dataset includes over 2 million comments on articles from January-May 2017 and January-April 2018. This dataset reveals public sentiment trends, which vary with policy changes and current events, highlighting the model's effectiveness with temporal relevance.
4. IPL: The Indian Premier League dataset provides match summaries from IPL matches (2008-2022). Match dates and summaries are used as timestamped documents.

After consolidating the documents, queries were generated using an LLM (in this experiment, llama-3.1-8b) by instructing the LLM to create a relevant query for each document.

The table below illustrates performance of the methods. SE refers to the semantic encoder, where a pretrained encoder was used. In SE+TRALM, the encoding function was used as described in Gade, supra. For SE+TE (Bos), a temporal encoder was applied utilizing Bochner's time encoding, while SE+TE (Mer) uses Mercer's embedding for temporal representation. The final method T-Ret is comprised of the entire approach.

The SE produces embeddings with a dimensionality of 1024, whereas the temporal embedding component yields embeddings of dimensionality 32. The aggregator network used generates output embeddings of dimension 1024.

Table 1 presents a comparative performance of various models, including T-Ret, evaluated on four datasets using metrics such as accuracy (Acc), mean reciprocal rank (MRR), and the hit rate measurements Hit@5 and Hit@10 to assess retrieval quality. T-Ret outperforms all other models by a significant margin in most of the datasets. The integration of the learnable Temporal Encoder (TE) achieves the second-highest performance. These scores demonstrate a substantial improvement over the baselines, particularly surpassing SE+TRALM, which incorporates the fixed temporal modeling technique introduced in Gade. These findings highlight the strength of T-Ret in prioritizing temporally relevant documents by unifying recency and semantic relevance in a single embedding space. Table 1, below, illustrates performance comparison across the above-noted datasets. The highest value in each column is in bold, while the second highest is underlined.

| | Tennis | | | | Politics | | | |
|---|---|---|---|---|---|---|---|---|
| Model | Acc | MRR | Hit@5 | Hit@10 | Acc | MRR | Hit@5 | Hit@10 |
| SE | 49.1 | 57.9 | 68.9 | 73.6 | 38.8 | 46.2 | 54.4 | 60.1 |
| SE + TRALM | 49.9 | 59.0 | 70.2 | 75.0 | 42.8 | 48.3 | 57.5 | 63.1 |
| SE + TE(Bos) | 61.6 | 69.5 | 79.3 | 83.1 | 45.1 | 52.1 | 60.0 | 65.2 |
| SE+ | 56.5 | 65.0 | 75.4 | 79.3 | 49.5 | 56.1 | 63.9 | 68.7 |
| T-Ret | 74.8 | 80.34 | 87.4 | 87.5 | 49.5 | 55.6 | 62.3 | 66.9 |
| | News Comments | | | | IPL | | | |
| Model | Acc | MRR | Hit@5 | Hit@10 | Acc | MRR | Hit@5 | Hit@10 |
| SE | 7.8 | 11.4 | 15.1 | 18.8 | 80.2 | 85.9 | 92.5 | 95.7 |
| SE + TRALM | 9.1 | 13.5 | 17.2 | 22.0 | 81.4 | 87.2 | 93.7 | 96.2 |
| SE + TE(Bos) | 11.6 | 16.3 | 20.9 | 25.7 | 85.2 | 89.5 | 95.2 | 97.7 |
| SE+ | 10.0 | 14.0 | 17.9 | 22.3 | 87.9 | 91.7 | 97.2 | 99.0 |
| T-Ret | 15.7 | 19.9 | 23.1 | 28.0 | 87.9 | 91.6 | 97.2 | 98.9 |

As illustrated in Table 1, the disclosed techniques outperform others in the field of temporal document retrieval. In some instances, the disclosed techniques are comprised of pre-trained sentence encoders and time-embeddings, which produce significantly good results out of the box, bypassing the need for training.

Moreover, inference time latency for the disclosed techniques is minimal, as all the document embeddings are computed only once and saved, requiring only the query to be embedded at runtime and a similarity metric (e.g., cosine similarity) to be computed.

### Illustrative Systems

The model T-Ret architecture and techniques described herein can be offered as a cloud computing service. For example, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

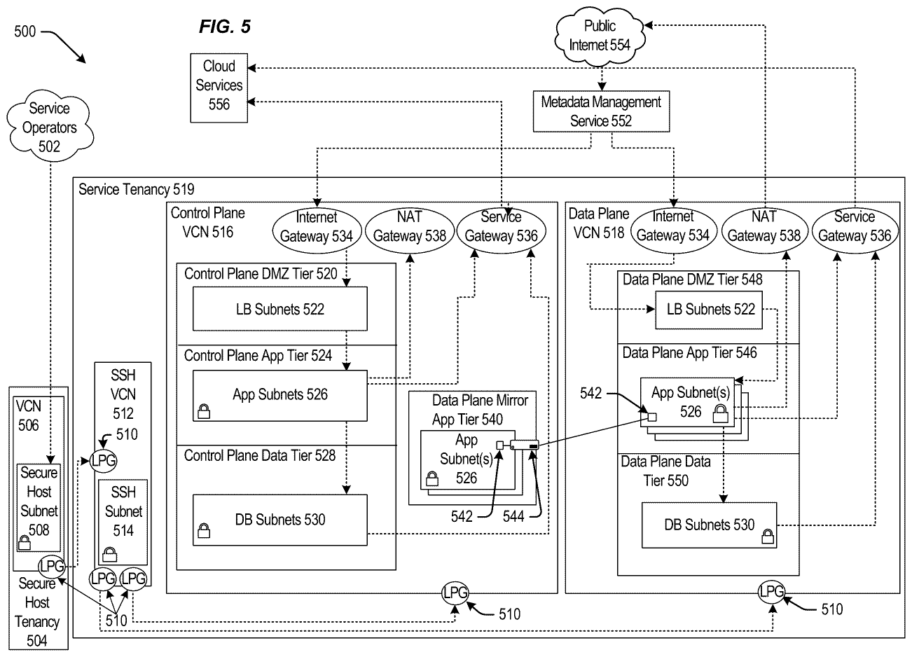

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

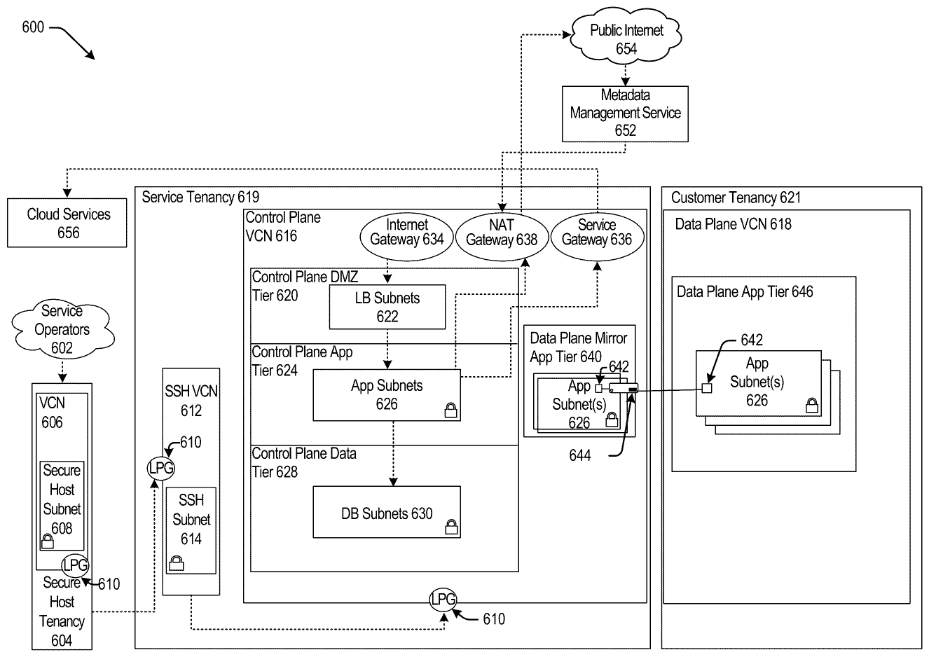

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

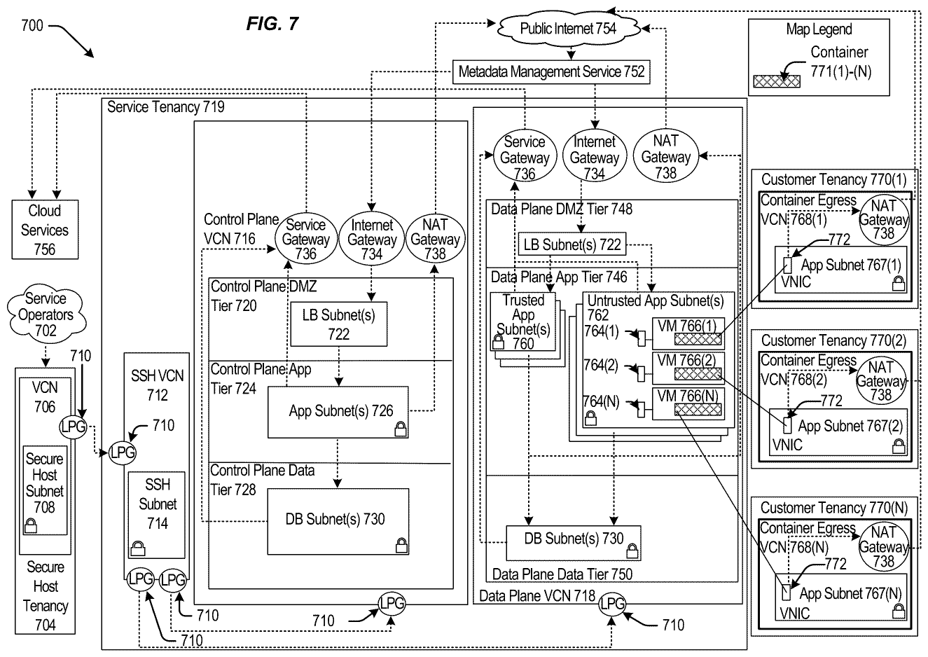

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764 (1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

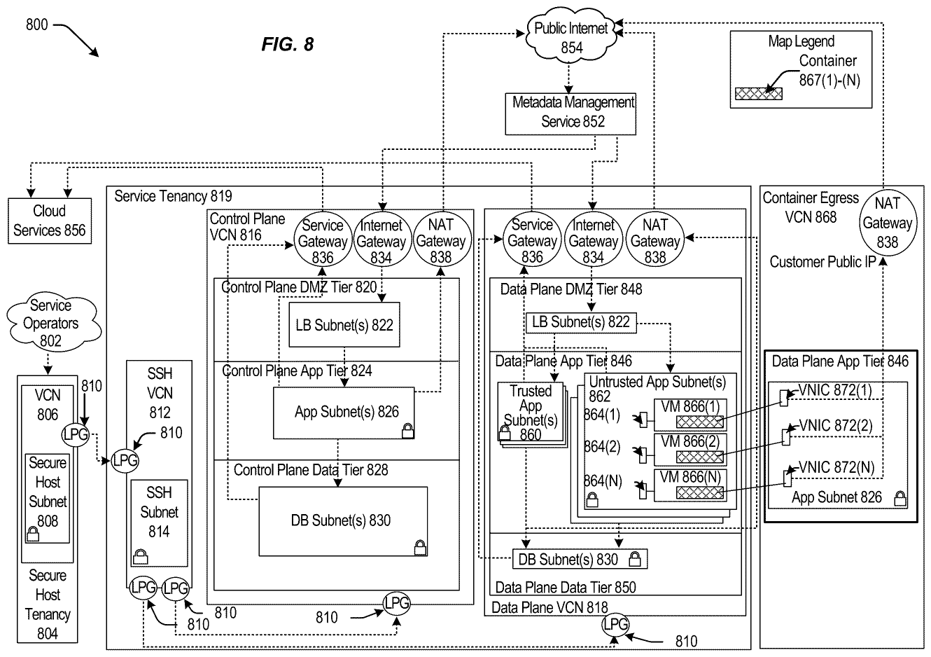

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

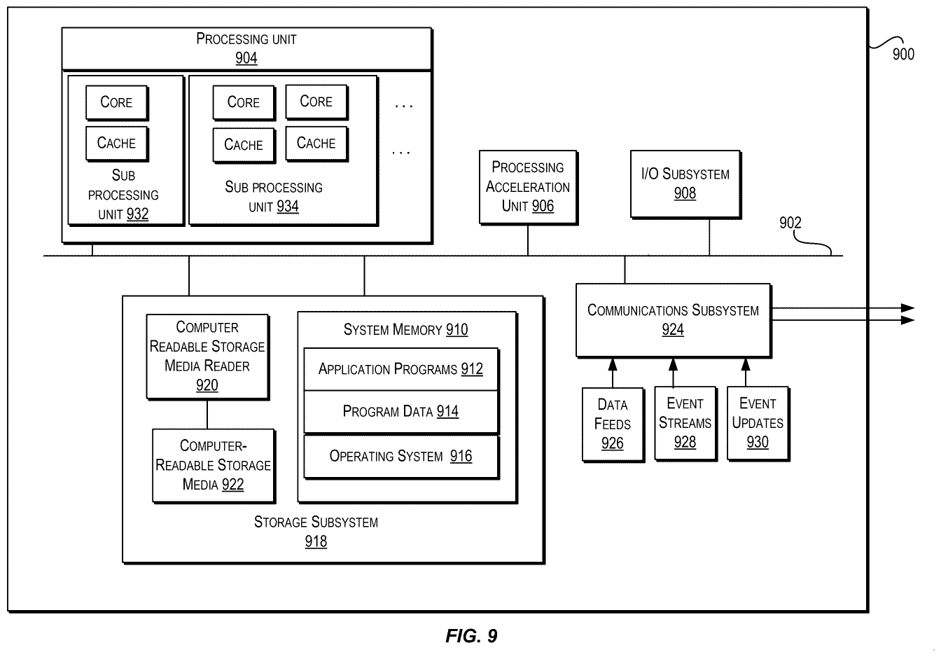

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein. In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed:

1. A computer-implemented method comprising:
accessing a set of documents;
generating a final unified representation for each document of the set of documents, wherein generating the final unified representation comprises performing an iterative process for each document, and wherein the iterative process comprises:
encoding, using a semantic embedding vector, a document's core semantic features in a semantic encoding,
mapping a time domain for at least the document into a dimensional vector space to encode temporal information into a temporal encoding, and
aggregating the semantic encoding and temporal encoding to generate the final unified representation;
generating a query embedding, where the query embedding comprises a time-aware embedding for a query;
comparing the query embedding to the final unified representation for each document of the set of documents;
identifying one or more documents of the set of documents based on the comparing; and
providing the one or more identified documents for downstream use.

2. The computer-implemented method of claim 1, further comprising:
ranking the one or more documents based on temporal relevance,
wherein the documents are provided based on the ranking.

3. The computer-implemented method of claim 2, wherein ranking the one or more documents based on temporal relevance comprises:
applying a Gaussian scoring method to enhance document prioritization based on temporal proximity.

4. The computer-implemented method of claim 1, wherein mapping the time domain into the dimensional vector space to encode the temporal information into the temporal encoding comprises:
applying Bochner's theorem to parameterize the temporal information.

5. The computer-implemented method of claim 1, wherein encoding the document's core semantic features in a semantic encoding comprises:
providing the document to encoder component of a transformer-based network that generates the semantic embedding vector.

6. The computer-implemented method of claim 1, wherein aggregating the semantic encoding and the temporal encoding comprises:
providing the semantic encoding and the temporal encoding to a neural network that aggregates the semantic encoding using weights for the semantic encoding and the temporal encoding.

7. The computer-implemented method of claim 1, wherein comparing the query embedding to the final unified representation comprises:
applying cosine similarity to the query embedding and the final unified representation to generate a score for the document.

8. The computer-implemented method of claim 1, wherein providing the one or more identified documents for downstream use comprises:
providing the one or more identified documents to a remote computing device for display.

9. The computer-implemented method of claim 1, wherein providing the one or more identified documents for downstream use comprises:
providing the one or more identified documents as input to a large language model (LLM) with the query;
receiving a natural language output from the LLM; and
providing the natural language output to a remote computing device for display.

10. A system comprising:
one or more processors;
a memory coupled to the one or more processors, the memory storing a plurality of instructions executable by the one or more processors, the plurality of instructions comprising instructions that when executed by the one or more processors perform a method comprising:
accessing a set of documents;
generating a final unified representation for each document of the set of documents, wherein generating the final unified representation comprises performing an iterative process for each document, and wherein the iterative process comprises:
encoding, using a semantic embedding vector, a document's core semantic features in a semantic encoding,
mapping a time domain for at least the document into a dimensional vector space to encode temporal information into a temporal encoding, and
aggregating the semantic encoding and temporal encoding to generate the final unified representation;
generating a query embedding, where the query embedding comprises a time-aware embedding for a query;
comparing the query embedding to the final unified representation for each document of the set of documents;
identifying one or more documents of the set of documents based on the comparing; and
providing the one or more identified documents for downstream use.

11. The system of claim 10, the method further comprising:
ranking the one or more documents based on temporal relevance,
wherein the documents are provided based on the ranking.

12. The system of claim 11, wherein ranking the one or more documents based on temporal relevance comprises:
applying a Gaussian scoring method to enhance document prioritization based on temporal proximity.

13. The system of claim 10, wherein mapping the time domain into the dimensional vector space to encode the temporal information into the temporal encoding comprises:
applying Bochner's theorem to parameterize the temporal information.

14. The system of claim 10, wherein encoding the document's core semantic features in a semantic encoding comprises:
providing the document to encoder component of a transformer-based network that generates the semantic embedding vector.

15. The system of claim 10, wherein aggregating the semantic encoding and the temporal encoding comprises:
providing the semantic encoding and the temporal encoding to a neural network that aggregates the semantic encoding using weights for the semantic encoding and the temporal encoding.

16. The system of claim 10, wherein comparing the query embedding to the final unified representation comprises:
applying cosine similarity to the query embedding and the final unified representation to generate a score for the document.

17. The system of claim 10, wherein providing the one or more identified documents for downstream use comprises:
providing the one or more identified documents to a remote computing device for display.

18. A non-transitory computer-readable memory storing a plurality of instructions executable by one or more processors, the plurality of instructions comprising instructions that when executed by the one or more processors cause the one or more processors to perform a method comprising:
accessing a set of documents;
generating a final unified representation for each document of the set of documents, wherein generating the final unified representation comprises performing an iterative process for each document, and wherein the iterative process comprises:
encoding, using a semantic embedding vector, a document's core semantic features in a semantic encoding,
mapping a time domain for at least the document into a dimensional vector space to encode temporal information into a temporal encoding, and
aggregating the semantic encoding and temporal encoding to generate the final unified representation;
generating a query embedding, where the query embedding comprises a time-aware embedding for a query;
comparing the query embedding to the final unified representation for each document of the set of documents;
identifying one or more documents of the set of documents based on the comparing; and
providing the one or more identified documents for downstream use.

19. The non-transitory computer-readable memory of claim 18, the method further comprising:
ranking the one or more documents based on temporal relevance,
wherein the documents are provided based on the ranking.

20. The non-transitory computer-readable memory of claim 19, wherein ranking the one or more documents based on temporal relevance comprises:
applying a Gaussian scoring method to enhance document prioritization based on temporal proximity.
